(19) United States
(12) Patent Application Publication
(10) Pub. No.: US 2012/0204811 A1
(43) Pub. Date: Aug. 16, 2012

(54) CELL COLLAR SYSTEM AND METHOD

(76) Inventor: Michael C. Ryan, Mitchellville, CA (US)

(21) Appl. No.: 13/397,571

(22) Filed: Feb. 15, 2012

Related U.S. Application Data
(60) Provisional application No. 61/443,232, filed on Feb. 15, 2011.

(51) Int. Cl. A01K 15/00; A01K 29/00

(52) U.S. Cl. 119/720

(57) ABSTRACT

Systems and methods for animal training, tracking, and monitoring are provided. The systems and methods include a command initiation system, a command receiving system, and a communication network. Through the components of the system, one can wirelessly control a device attached to an animal.

### PRIORITY CLAIM

The present invention claims priority to and the benefit of U.S. Provisional Application No. 61/443,232 filed on Feb. 15, 2011, the contents of which are incorporated herein by reference.

### BACKGROUND OF THE INVENTION

1. Field of the Invention

The present invention is generally related to training, tracking, and monitoring animals. More particularly, the present invention pertains to a system and method for wirelessly controlling a device attached to an animal.

2. Introduction

People involved in the training and management of animals recognize that proper management is essential for their health, longevity, enjoyment and production capabilities. Throughout the history of the management of animals, owners have had to learn how to control and monitor their animals. For example, a responsible dog owner exercises the dog, keeps the dog in a safe environment, protects others from possible harm from the dog and tries to train the dog to live in its environment (e.g., controls barking). A variety of systems and methods have attempted to provide owners with tools to effectively monitor and train their animals. However, many of those tools are inflexible, single purpose, complicated and limited in the features offered. What is needed is a system and method that enables an animal owner to effectively and flexibly manage their animals while minimizing the cost and complications of other single purpose and/or inflexible devices.

### SUMMARY OF THE INVENTION

While the way in which the present invention addresses the disadvantages of the prior art will be discussed in greater detail below, in general, the present invention are systems and methods for facilitating the training, tracking, and monitoring of animals. The systems and methods provide for wirelessly controlling a device attached to an animal.

An animal training, tracking, and monitoring system includes a command initiation system, a command receiving system, and a network for communicating between the systems. The command initiation system may utilize any hardware and/or software suitably configured to initiate a command recognizable by the command receiving system. The command initiation system may initiate a training, tracking or monitoring command through short-range or long-range communication methods. In one embodiment, the command initiation system comprises a smart phone. The command receiving system may utilize any hardware and/or software suitably configured to receive a command from the command initiation system and execute the command through a portion of the system that is attached to an animal. The command receiving system may comprise one or more units in communication with each other over a network. In one embodiment, the command receiving system is a collar attached around the neck of an animal.

A method for wirelessly controlling a device attached to an animal includes the steps of initiating a command at a portable device, wirelessly sending the command to a receiving device attached to an animal, and executing, by the receiving device attached to the animal, the received command. A user and/or portable device using software applications executing on the portable device may initiate the various commands. Exemplary software applications, or feature sets, enable the ability to create containment boundaries, stimulate an animal, track and monitor movement patterns, retrieve animal health statistics, establish a repulsion zone around a portable device, eliminate barking, and other types of animal management functions.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary animal training, tracking and monitoring system.

FIG. 2 illustrates an exemplary embodiment of a command receiving device.

FIG. 3 illustrates an exemplary method for wirelessly controlling a device attached to an animal.

FIGS. 4-5 illustrate exemplary feature sets implementing a method for wirelessly controlling a device attached to an animal.

### DETAILED DESCRIPTION OF THE INVENTION

Various embodiments of the invention are described in detail below. While specific implementations involving electronic portable or mobile devices (e.g., smart phones) are described, it should be understood that the description here is merely illustrative and not intended to limit the scope of the various aspects of the invention. A person skilled in the relevant art will recognize that other components and configurations may be easily used or substituted than those that are described here without parting from the spirit and scope of the invention.

The present invention facilitates training, tracking, and monitoring animals. In particular, the invention provides a system and method for wirelessly controlling a collar or similar device attached to an animal. Thus, as will become apparent from the following descriptions, the system and methods of the invention facilitate initiating a command at a portable device, wirelessly sending the command to a device attached to an animal, and executing, by the device attached to the animal, the received command.

For the sake of brevity, conventional data networking, application development and other functional aspects of the systems (and components of the individual operating components of the systems) may not be described in detail. The connecting lines shown in the various figures are intended to represent exemplary functional relationships and/or physical couplings between various elements. It should be noted that many alternative or additional functional relationships or physical connections may be present in a practical system.

The invention may be described in terms of functional block components, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, audio and/or visual elements, input/output elements, wired or wireless communication techniques, and the like, which may carry out a variety of functions under the control of one or more microprocessors or other control devices.

Similarly, the software elements of the invention may be implemented with any programming, scripting language or web service protocols such as C, C++, C#, Java, COBOL, assembler, and the like. As those skilled in the art will appreciate, the software and hardware elements may be implemented with an operating system such as Microsoft Windows®, Microsoft Mobile, UNIX, Apple OS X, MacOS, Apple iOS, Android, Linux, and the like. Software elements may also include utilizing the services of a cloud-based platform or software as a service (SaaS) to deliver functionality to the various system components.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, DVDs, optical storage devices, magnetic storage devices, solid state storage devices and/or the like.

The computer program instructions may be loaded onto a general purpose computer, special purpose computer, or other programmable data processing apparatus to produce a machine, such that the instructions execute on the computer or other programmable data processing apparatus and create means for implementing the functions specified in the flowchart block or blocks. The computer program instructions may also be loaded onto a computer or other programmable data processing apparatus to cause a series of operational steps to be performed on the computer or other programmable apparatus to produce a computer-implemented process such that instructions which execute on the computer or other programmable apparatus provide steps for implementing the functions specified in the flowchart block or blocks.

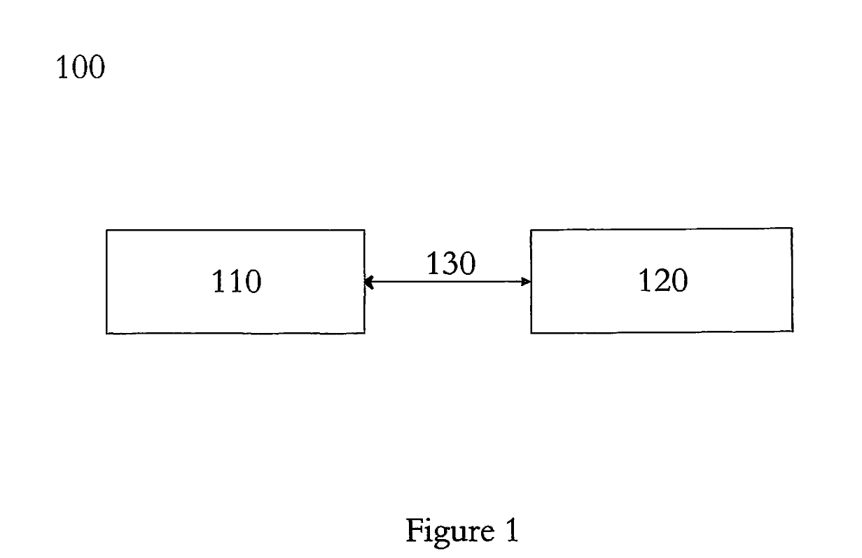

FIG. 1 illustrates, in block format, an exemplary animal training, tracking and monitoring (TTM) system 100 of the invention. In one embodiment, an animal TTM system comprises a command initiation system (CIS) 110 and a command receiving system (CRS) 120. A portion of the command receiving system 120 is attached to the target animal. Depending on the physical configuration, these systems may use a variety of methods to communicate with each other. For example, in some embodiments, the systems may communicate over one or more networks 130 using protocols suited to the particular system and communication. As used herein, the term “network” shall include any electronic communications means which incorporates both hardware and software components. Communication among the systems may be accomplished through any suitable communication channels, such as, for example, a telephone network, an extranet, an intranet, Internet, portable computer device, personal digital assistant, online communications, satellite communications, off-line communications, wireless communications, transponder communications, local area network, wide area network, networked or linked devices, keyboard, mouse and/or any suitable communication or data input modality. In some embodiments, the CIS 110 and CRS 120 may share hardware and software components. In other embodiments, each system is contained within a single physical unit and appropriately coupled through various integrated circuit components. In various embodiments, a CIS 110 system is contained within a cell phone or smart phone device and a CRS 120 system may be entirely contained within an animal's collar. In an exemplary embodiment, a CIS 110 system is contained within a smart phone device and a CRS 120 system is contained in an animal's collar and an RFID-chip implanted in the animal.

The command initiation system (CIS) 110 includes any hardware and/or software suitably configured to initiate a command recognizable by the command receiving system (CRS) 120. In general, the CIS 110 is implemented as a combination of portable hardware and application software configured to initiate a training, tracking or monitoring commands to the CRS 120, which is at least partially coupled to a target animal. Once a command is initiated, the command is wirelessly sent over a network 130 to the receiving system. The CIS 110 may be configured to send its commands in a variety of communication methods as described above. In some embodiments, the CIS 110 is configured to send commands via short-range communication such as Bluetooth. In other embodiments, the CIS 110 is configured to send commands via long-range communication such as satellite communication or cell phone tower communication methods. In an exemplary embodiment, the CIS is configured to send short and long-range communications, which may be used simultaneously. Short and long-range communication methods are well known in the art and any method suitable to the particular application is within the spirit and scope of the invention. In one embodiment, the CIS 110 is a cell phone. In an exemplary embodiment, the CIS 110 is a smart phone.

The command receiving system (CRS) 120 includes any hardware and/or software suitably configured to receive a command from the CIS 110 and execute the command through the portion of the CRS attached to an animal. In general, the CRS 120 is implemented as a combination of portable hardware and software configured to implement the command received from the CIS. The CRS 120 may consist of one unit or multiple units in communication with each other via a network 130. In one embodiment, the CRS 120 consists of a collar or similar device attached around the neck of the target animal. In another embodiment, the CRS 120 consists of a collar attached around the neck of the target animal in communication with an RFID-chip, or other similar device, implanted in the target animal. In one embodiment, more than one collar attached to more than one animal may comprise the CRS. In this embodiment, the CIS 110 may initiate a command that is received by all or some of the collars attached to the multiple animals. In other embodiments, the CRS is attached to the animal using an adhesive. In another embodiment, the CRS is situated under the skin of the animal. In yet another embodiment, the CRS is mechanically attached to the animal.

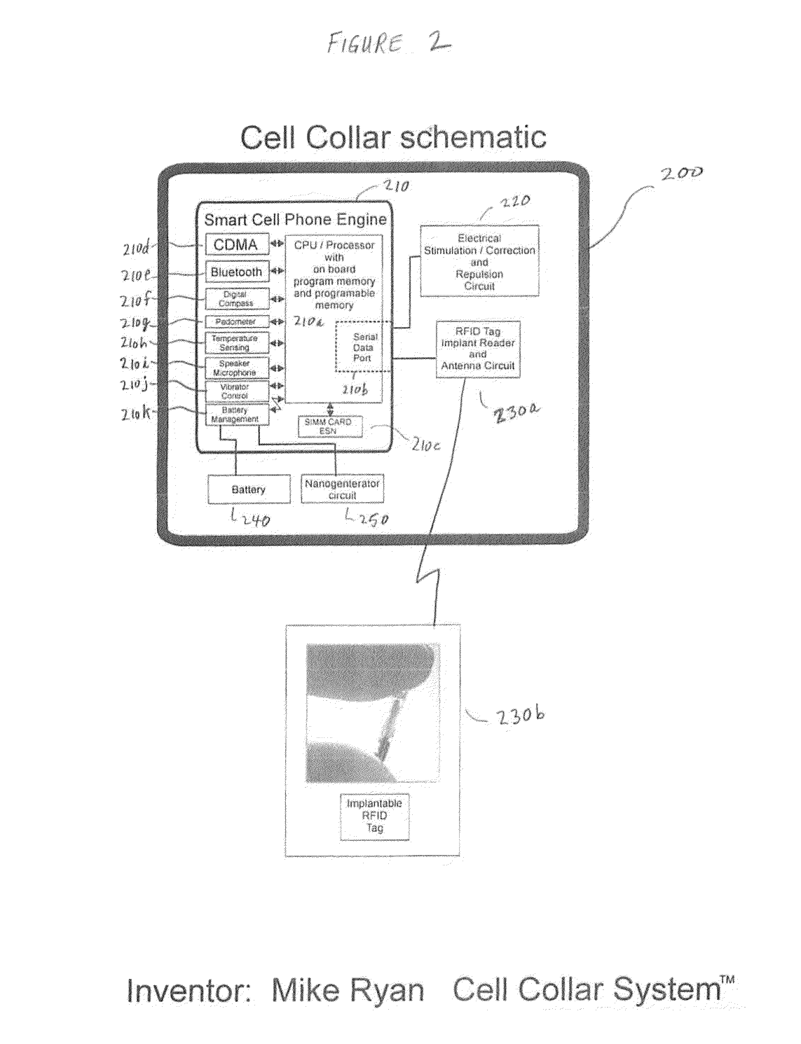

FIG. 2 illustrates an exemplary embodiment of a CRS device 200 that is attached around the neck of a target animal. Exemplary modules are described below, however, it is understood that additional modules may be implemented within or on the CRS device 200 depending on the specific application. In this embodiment, a smart cell phone engine 210 is coupled to an electrical stimulation/correction and repulsion circuit 220. The electrical stimulation/correction and repulsion circuit 220 is configured to deliver varying levels of stimulation to the animal attached to the CRS device 200. The type of stimulation delivered may be electrical or mechanical or both depending on the application. However, any type of stimulation known now or hereafter discovered suitable for the particular animal is within the scope of the invention.

Continuing with this embodiment, the smart cell phone engine 210 is also coupled to an RFID tag implant reader and antenna circuit 230a. The RFID tag implant reader and antenna circuit 230a wirelessly communicates with an RFID tag 230b implanted in the animal attached to the CRS 200 device. Various data collected at the RFID tag 230b may be communicated wirelessly to the RFID tag implant reader and antenna circuit 230a. Such data may include, but is not limited to, the body temperature of the animal, an identification code assigned to the animal, time, date, and other information provided by the RFID tag depending on application.

The smart cell phone engine 210 is also coupled to a battery 240. Batteries for such electronic applications are well known and will not be described. However, the battery 240 must be a suitable power source to power all elements of the smart cell phone engine 210 as it operates in varying animal and weather environments. Battery 240 may also include a backup battery to provide emergency power to necessary components of the smart cell phone engine 210 in case of main battery failure.

The smart cell phone engine 210 is optionally coupled to a nanogenerator circuit 250. This circuit 250 converts mechanical or kinetic energy to electrical energy that may be used to assist the battery 240 to meet the power needs of the CRS device. In another embodiment, the nanogenerator circuit 250 may be the sole power source. Thus, through this circuit 250 the animal assists with powering the CRS device providing for long-term usage of the system.

The smart phone cell engine 210 includes suitable hardware and/or software to provide for the particular application of the system. The smart phone cell engine 210 includes a processor coupled to a memory. Coupled to the processor is a serial data port 210b. Additionally, modules based on the intended use are coupled to the processor to provide the functionality for the system. Even though the exemplary embodiment is described below with particular functionality, it is understood that portions of the system may be modified, added, or deleted to acquire the needed functionality for the overall successful operation of the system. In the exemplary embodiment, the smart cell phone engine includes a SIMM card 210c, CDMA (4GLte) module 210d, Bluetooth module 210e, digital compass module 210f, pedometer module 210g, temperature sensing module 210h, speaker and/or microphone module 210i, vibrator control 210j, and battery management module 210k. CDMA (4GLte) module 210d, Bluetooth module 210e, speaker and/or microphone module 210i, vibrator control, battery management module 210k, and SIMM card 210c are elements well known in the industry and will not be described.

Digital compass module 210f includes hardware and/or software for providing heading information to the system. For example, mapping software configured to locate and track the animal attached to the CRS device will consult the digital compass module 210f for the appropriate data. Pedometer module 210g provides distance-traveled data for the particular animal. Temperature sensing module 210h provides temperature data of the animal and the environment that the animal is in. In another embodiment, a camera module (not pictured) includes hardware and/or software providing camera functionality. One or more cameras may be mounted within and/or on the CRS device.

The CIS 110 is configured to provide training, tracking, and monitoring (TTM) features to control, manipulate, and monitor the CRS 120. Any hardware and/or software suitably configured to provide such features are within the scope of the invention. Features available on the system may include any suitable activity used to track, locate, contain, train or manage the health concerns of the animal attached to the command receiving system. Exemplary features are described below, however, it is understood that additional features may be implemented to control the CIS and CRS depending on the specific application. In various embodiments, the features are made available to the CIS 110 as application software. In an exemplary embodiment, the CIS 110 is a smart phone and the features are downloadable as an “app” or multiple “apps” from a software distribution platform such as Apple's App Store® or the Android Market®. Additionally, such features may be accessible via a user interface such as a touch screen, keyboard, display, audio receiver, or a combination thereof and the like. The user interface and therefore the CIS 110 may be manipulated by touch or audio commands. For example, in a smart phone, a user may access a particular application to manipulate and issues commands to the system. In another embodiment, a user may initiate voice commands to the system interpreted by voice recognition hardware and/or software.

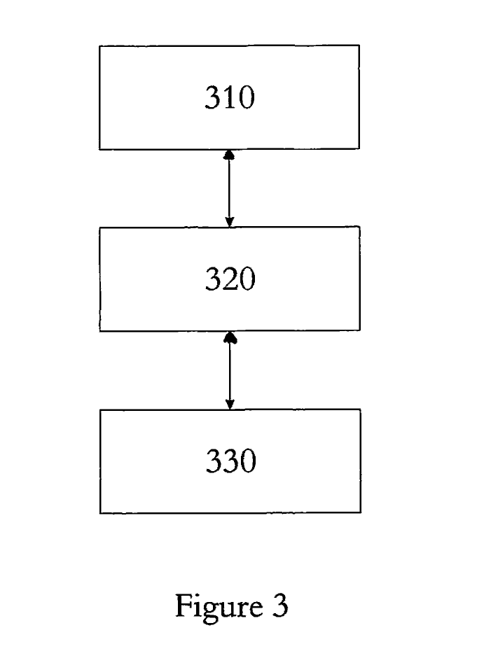

FIG. 3 illustrates, in block format, a method for wirelessly controlling a device attached to an animal. In this method, controlling a device attached to an animal comprises the step of initiating a command at a portable device 310, wirelessly sending the command to a receiving device attached to an animal 320, and executing, by the receiving device attached to the animal, the received command 330. It is understood that a processor within the receiving device accomplishes command execution in accordance with the instructions received and the software invoked for the particular application.

Many commands can be initiated from the portable device depending on the desired application. For example, commands may be integrated into a software application executing on the portable device. In various embodiments, a software application is downloaded on the portable device designed specifically to issue commands to a receiving device. Software applications may vary by the type of training, tracking and monitoring needed for a specific animal. A user accesses the commands through a user interface and/or display at a portable device. As described above, such access may be accomplished via touch screen, keyboard or keypad, voice or a combination thereof. Though features embodied as software applications are described below, many types of features aimed at controlling a device attached to an animal are understood to be within the scope of the invention. The features described below are not intended to be limiting.

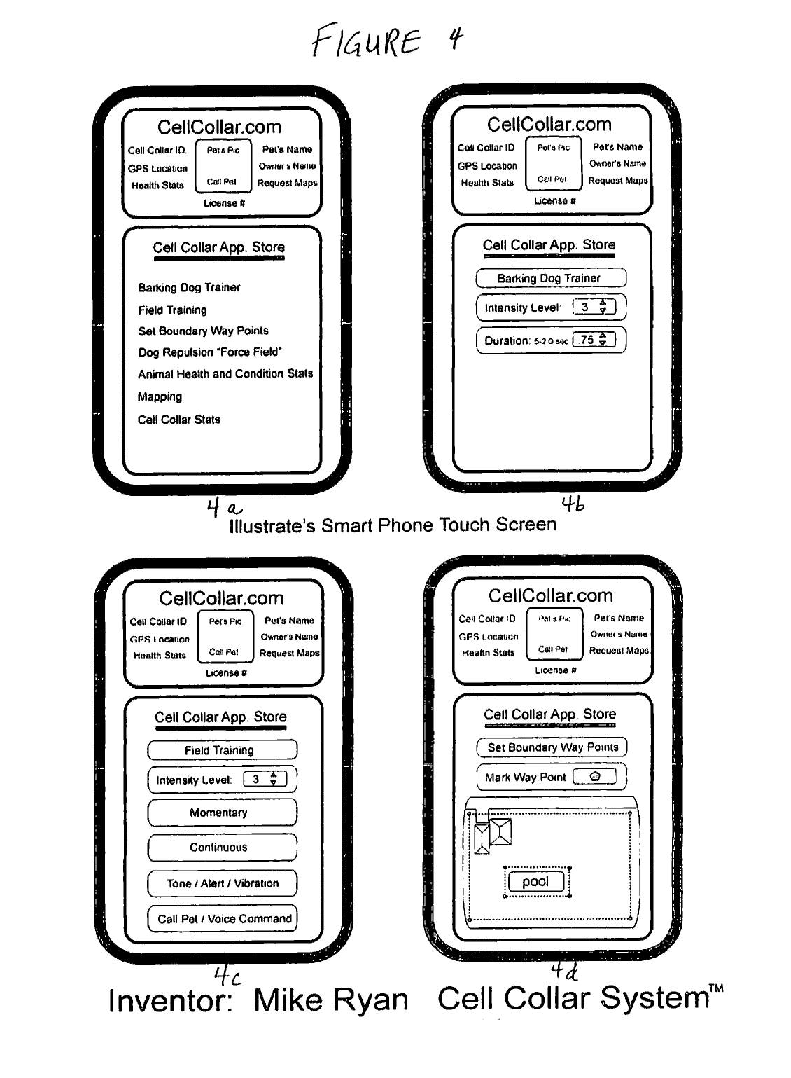

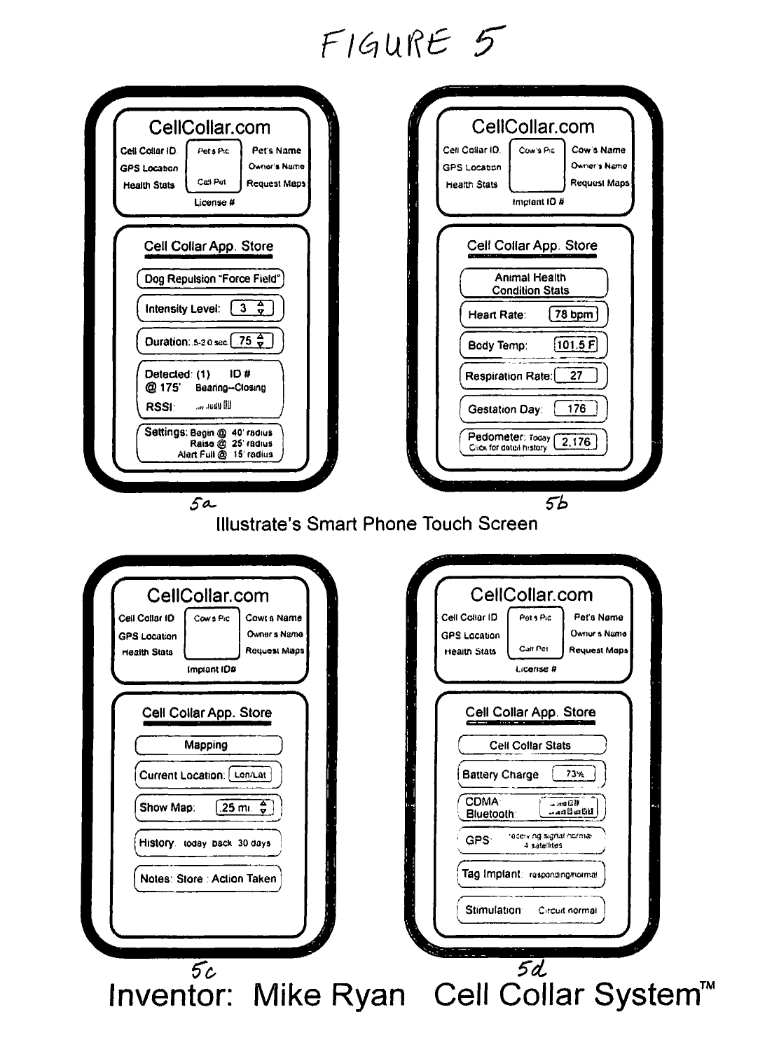

One such feature set is the ability to establish, modify, or delete a containment boundary for the target animal is illustrated by FIGS. 4d and 5c. With the use of GPS technology, cell phone tower triangulation and other similar technologies, the location of a receiving device attached to an animal may be ascertained. Through the display of the portable device, a map may be accessed of a target area that a user may wish to contain (or keep out) an animal. For example, waypoints or boundary markers may be set on a map display by touching the display screen. When the boundary markers are set, the portable device issues commands through a network to the receiving device, for example, a dog collar. When an animal encounters the boundaries, a stimulation command is issued to the device, which in turn executes the command thereby stimulating the animal. In various embodiments, several characteristics of the boundary may be established. For example, boundaries representing concentric circles or squares may be set so that an animal receives varying levels of stimulation based on the location within the greater boundary. If an animal wanders into the first zone, a small stimulation may be issued to the animal to warn of an impending boundary. If the animal continues to approach the greater boundaries' edge, stimulation greater in degree may be issued as a sterner warning. In another embodiment, multiple boundaries may be established within a single mapping space. For example, a user may wish to set boundaries to keep an animal out of garden and pool areas, but allow the animal to roam anywhere within a much larger area. The appropriate boundaries and waypoints may be set at the portable device and the appropriate commands establishing those waypoints are sent to the receiving device.

Another feature set is the ability to track and monitor traveling patterns of the device attached to the animal as illustrated by FIGS. 4d, 5b and 5c. Through the user interface of the portable device, the user may issue a command to the receiving device attached to the animal to set, retrieve or other modify pedometer data provided by the pedometer within the receiving device. In an exemplary embodiment, the portable device issues a command to the receiving device attached to an animal that retrieves the number of steps taken, distance traveled, and additional mapping information to reveal the path of the travel throughout the day. The receiving device executes the command and sends back the requested information. With this information various analyses may be performed at the portable device, for example, within a software application, or downloaded to other devices or applications.

Additional health statistics may be collected from the receiving device as illustrated by FIG. 5b. In one embodiment, the temperature of the animal is retrieved from the temperature-sensing module of the receiving device. In other embodiments, animal health statistics such as heart rate, breathing rates, gestation period, attempts at breeding by gomer bulls and the like may be retrieved. In various embodiments, the data captured may be from the receiving device attached to the animal, the RFID tag, or both. Any health data may be retrieved from a particular animal provided sensing devices are properly placed on or within the animal and communicate with the receiving device. The collection of the statistics may then be controlled from a user's portable device.

Another feature set is the ability to establish, modify or delete a repulsion zone between a portable device and the receiving device attached to the animal as illustrated by FIG. 5a. The repulsion zone is an area of a certain diameter or other type of shape established around a portable device participating in the system of the invention. As an animal with the receiving device approaches a user with a portable device within the established boundaries, the portable device issues a command to the receiving device to stimulate the animal. In an exemplary embodiment, a portable device communicates with the receiving device attached to the animal via short-range communication such as Bluetooth communication to establish that the portable device wishes to have the ability to issues command according to the repulsion feature set. In the case of Bluetooth communication, the strength of the Bluetooth signal between the portable device and the receiving device, e.g., the Relative Signal Strength Indicator (RSSI)) is analyzed by the portable device to determine if a stimulation command should be issued. Security provisions may be enabled to ensure that only proper user's with approved portable devices may issue commands. Security provisions may be application software or hardware-based. Such security and authentication procedures are well known in the art and will not be described.

FIG. 4b illustrates a dog barking eliminator embodiment of the present invention. In this embodiment, a user may set the parameters as to the intensity level and duration of stimulation when a dog start barking. Once the parameters are set, the portable device issues the commands to the receiving device attached to the animal, in this case a dog. When the receiving device detects barking, the receiving device executes the stimulation command according to the parameters.

FIG. 5d illustrates an embodiment of the present invention that enables a user to monitor and maintain the health and status of the receiving device. In this embodiment, statistics such as battery charge levels, signal strength, GPS status, RFID tag implant status, and stimulation circuit status may be displayed. Any statistics or status about the receiving device or other components of the system may be monitored and reported on and are within the scope of the invention.

Another embodiment of the method of wirelessly controlling a device attached to an animal is wirelessly accessing an RFID tag and identification information associated with the tag, and comparing the RFID tag and identification information with identification information of the receiving device. Receiving devices may become separated from the target animal. As a result, the receiving device would fail to retrieve any information from an RFID tag. Should that occur, the receiving device might disable its ability to receive any command until receiving a proper “reset” or “enablement” instruction or proper RFID tag and identification information. In some embodiments, such a “reset” or “enablement” instruction may be issued from a remote device such as a service center for the receiving devices or a manufacturer of the receiving devices. Additionally, should the incorrect RFID tag and identification information be received, the receiving device may disable itself. Such a security procedure prevents the wrong receiving device being placed on the wrong animal. Furthermore, data captured from the RFID tag may be transmitted from the RFID tag to the receiving device and in turn through a network to a remote server and attached database for capturing and compiling various statistics such as receiving device location, battery charge status, time, date, heading, last captured GPS location and the like. For example, from this data a lost pet whose collar had been disabled in some manner could be found by correlating the data.

Additionally, should the collar stop receiving responses from the implanted RFID tag in an animal, the collar may identify the lack of response as a distress situation and issue a distress call to the owner/manager/caretaker of the animal and include the last set of known data received from the RFID tag.

Although the above description may contain specific details, they should not be construed as limiting the claims in any way. Other configurations of the described embodiments of the invention are part of the scope of this invention. The descriptions and embodiments are not intended to be an exhaustive or to limit the invention to the precise forms disclosed. Accordingly, the appended claims and their legal equivalents should only define the invention, rather than any specific examples given.

What is claimed is:

1. A method for training, tracking, and monitoring an animal, the method comprising the steps of:
initiating a command at a portable device;
wirelessly sending the command to a device attached to an animal; and
executing, by the device attached to the animal, the command.

2. A system for training, tracking, and monitoring an animal comprising:
a command initiation system;
a command receiving system wherein at least a portion of the command receiving system is attached to an animal; and
a network wirelessly coupled to the command initiation system and the command receiving system.
